(19) United States
(12) Patent Application Publication
(10) Pub. No.: US 2010/0024162 A1
(43) Pub. Date: Feb. 4, 2010

(54) Engine Hood Hinge

(75) Inventor: Steffen Walz, Herrenberg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG

(21) Appl. No.: 12/297,078

(22) PCT Filed: Apr. 3, 2007
(86) PCT No.: PCT/EP2007/002988

§ 371 Date: Aug. 25, 2009

(30) Foreign Application Priority Data
Apr. 15, 2006 (DE) 10 2006 017 730.4

(51) Int. Cl. E05D 7/00

(52) U.S. Cl. 16/233

(57) ABSTRACT

An engine hood hinge for an engine hood can be transferred from an operating position into a protective position and pivoted about an engine hood pivot into an open position. The engine hood pivot is mounted on a supporting structure of a motor vehicle via a lever mechanism, and the engine hood, as it transfers from the operating position into the protected position, carries along the engine hood pivot. In order to provide a robust engine hood hinge, the lever mechanism is designed as a multi-bar linkage mechanism, in particular as a four-bar linkage mechanism.

### BACKGROUND AND SUMMARY OF THE INVENTION

This invention relates to an engine hood hinge for an active engine hood.

In series manufacturing of vehicles, an engine hood hinge for an active engine hood has to be suitable both for opening the engine hood for service and repair purposes and for erecting the engine hood in the event of an accident with a pedestrian.

An engine hood hinge of this type is disclosed in German document DE 100 33 186 A1. This engine hood hinge comprises a bearing, which is fastened to the supporting structure of the motor vehicle. A lever mechanism is mounted pivotably in the bearing and is in turn fastened pivotably to the engine hood. The lever mechanism has an axis about which the engine hood can be pivoted into its open position for service and repair purposes. In addition, in the event of an accident with a pedestrian, the engine hood hinge may transfer the engine hood into its protective position via a separate hood-raising actuator. For a reversible, active engine hood, a hood-returning actuator is provided for moving the engine hood from its protective position back into the operating position.

The object of the invention is therefore to provide a simple and cost-effective engine hood hinge which is also robust.

This object is achieved according to the invention by the features claimed. Advantageous refinements are also claimed.

An engine hood hinge according to the invention comprises at least two pivots. One of the pivots is the engine hood pivot about which the engine hood can be pivoted from its operating position into its open position. At least two further pivots about which the engine hood is pivoted into its protective position are formed by a multi-bar linkage, in particular a four-bar linkage. A multi-bar linkage is understood to be a linkage with a coupling element that can be moved on a coupling path by two or more rockers having first ends on a base, here the supporting structure. If, within the context of the invention, the operating position of the engine hood is spoken of, then this means that the engine hood is closed. The open position designates the position of the engine hood in which service and repair work can be carried out in the engine compartment. For this purpose, the engine hood is usually released by the driver and is then pivoted upward about the engine hood pivot of the engine hood hinge. The protective position designates a raised position of the engine hood after an imminent impact with a pedestrian is sensed, in which case the engine hood is pivoted about a pivot arranged in the front region of the front part. The lever mechanism is mounted pivotably via its rocker axes on the supporting structure of the motor vehicle in order to permit the engine hood to be erected. The engine hood hinge can be a very compact design by means of the two pivots on the lever mechanism. Additional hood-raising or hood-returning actuators are not required. The engine hood hinge is accordingly very simple and highly robust.

The engine hood pivot can preferably be arranged on a lever arm which acts as a coupling element. Accordingly, when the engine hood is erected by the lever arm, the engine hood pivot is carried along at the same time.

If the pivots of the multi-bar linkage, in particular of the four-bar linkage, which pivots act on the lever arm, run substantially parallel to the engine hood pivot, the engine hood hinge can be further simplified structurally.

If the lever is kept under prestress in the operating position of the engine hood, then that prestress can be released upon activation and used for the pivoting movement of the lever.

The prestress can be produced in a simple manner by means of a spring, which is fastened at its one end to a free end of a rigid angle bracket protruding from the lever arm and at its other end to the supporting structure.

The lever arm can advantageously be held by a retaining clip in a pawl which can be actuated by a trigger, in particular a magnetic trigger. If the trigger is activated, the pawl opens and releases the retaining clip. The lever arm which is kept under prestress can then be pivoted about its axes with the assistance of the tensile force of the spring.

An advantageous embodiment of the invention is explained in more detail below with reference to the drawings.

### BRIEF DESCRIPTION OF THE DRAWINGS

FIG. 1 shows a front part of a motor vehicle with an engine hood in the operating position,

FIG. 2 shows the front part according to FIG. 1 with an engine hood in the raised protective position,

FIG. 3 shows an engine hood hinge in the operating position of the engine hood, and

FIG. 4 shows an engine hood hinge in the raised protective position of the engine hood.

### DETAILED DESCRIPTION OF THE INVENTION

FIG. 1 shows a front part 1 of a passenger vehicle (not illustrated specifically). The front part 1 comprises a fender 2 and an engine hood 3, which is coupled to the supporting structure of the passenger vehicle by an engine hood hinge 4. For repair or service work, the engine hood 3 can be pivoted according to the arrow direction A about the engine hood hinge 4 into the open position (broken lines).

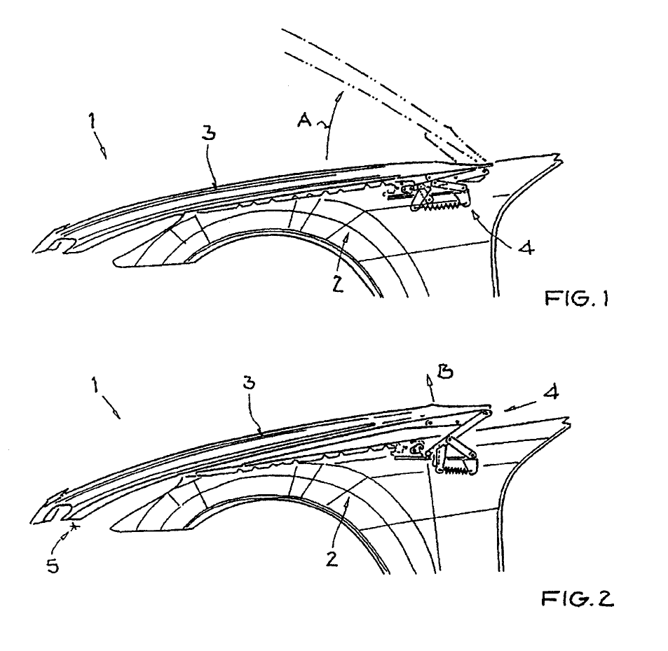

In order to provide a relatively large deformation distance for a pedestrian with respect to the hard vehicle parts arranged below the engine hood 3, such as, for example, the engine block, the engine hood hinge 4 is designed in such a manner that the engine hood 3 can be transferred into a raised protective position. This protective position is illustrated in FIG. 2. The engine hood 3 is erected from the operating position into the protective position by the engine hood 3 pivoting according to the arrow B about a pivot 5 arranged in the front region of the front part 1.

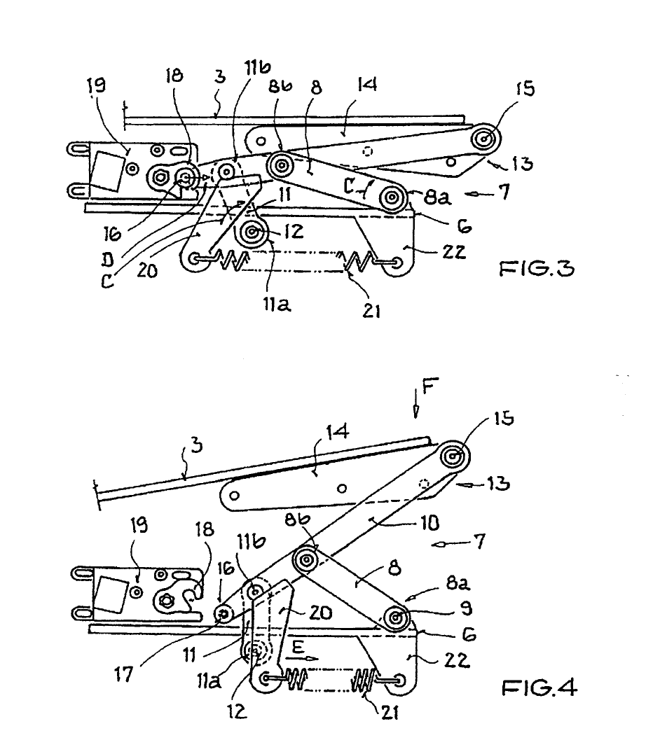

The construction and the operation of the engine hood hinge 4 are explained in more detail with reference to FIGS. 3 and 4.

The engine hood hinge 4 is fastened to a supporting structure 6 of the passenger vehicle. For this purpose, the engine hood hinge 4 has a lever mechanism 7 in the form of a four-bar linkage which is fastened to the supporting structure 6. A long rocker 8 is fastened pivotably at its end 8a to the supporting structure 6, thereby forming a pivot 9. At its other end 8b, the rocker 8 is likewise connected pivotably to a lever arm 10, which acts as a coupling element. Analogously to the long rocker 8, a short rocker 11 is connected at its one end 11a to the supporting structure 6 and at the opposite end 11b to the lever arm 10. Both the short rocker 11 and the long rocker 8 can pivot about their respective axes 9 and 12 according to the arrow C and, in the process, can position the lever arm 10 obliquely.

At its rear end 13, as seen in the direction of travel, a support 14 is coupled pivotably about an engine hood pivot 15, with the engine hood 3 being fastened to the support 14. The engine hood 3 can be pivoted from its operating position into its open position about this engine hood pivot 15.

A retaining clip 17, which, in the operating position of the engine hood 3, is fixedly secured in a pawl 18 of a trigger 19, in particular of a magnetic trigger, at its front end 16, as seen in the driving direction.

A rigid angle bracket 20, on the free end 20a of which a spring 21 acts, protrudes from the rear end 13. The spring 21 is kept under prestress in the operating position of the engine hood 3 by that end of the spring 21 which lies opposite the rigid angle bracket being fastened to a bearing bracket 22 protruding from the supporting structure 6.

If an accident with a pedestrian is then sensed, the trigger 19 opens its pawl 18 and the retaining clip 17 moves to the rear, as seen in the direction of travel, in the arrow direction D. The angle bracket 20 which is kept under prestress is deflected in the arrow direction E by the tensile movement of the spring 21 such that the lever arm 10 is positioned obliquely upward about the pivots 9 and 12 of the rockers 8 and 11.

The kinematics of the four-bar linkage can be changed by simple shifting of the positions of the pivot points such that adaptation to the surroundings of the vehicle, such as, for example, the engine hood contour or the configuration of the front end, is readily possible.

Should triggering take place in error or should there not be any contact at all with the pedestrian, then by means of application of force according to the arrow F on the rear end of the engine hood 3, with the spring force being overcome, the engine hood hinge can be brought again into the operating position without auxiliary means or a workshop visit being required. The retaining clip 17 thereby moves back in the opposite direction to the arrow direction D toward the trigger 19 where it latches again in the pawl 18.

1-7. (canceled)

8. An engine hood hinge for an engine hood that can be transferred from an operating position into a protective position, comprising:
an engine hood pivot about which the engine hood can be pivoted into an open position, and
a lever mechanism by which the engine hood pivot is mounted on a supporting structure of a motor vehicle,
wherein the engine hood, as it transfers from the operating position into the protective position, carries along the engine hood pivot, and
wherein the lever mechanism is designed as a multi-bar linkage mechanism.

9. The engine hood hinge as claimed in claim 8, wherein the engine hood pivot is arranged on a lever arm acting as a coupling element.

10. The engine hood hinge as claimed in claim 9, wherein pivots of the multi-bar linkage are arranged on the lever arm and run substantially parallel to the engine hood pivot.

11. The engine hood hinge as claimed in claim 9, wherein the lever arm is kept under prestress.

12. The engine hood hinge as claimed in claim 11, wherein the prestress is produced by a spring, which acts on the lever arm via a rigid angle bracket.

13. The engine hood hinge as claimed in claim 9, wherein the lever arm is held by a retaining clip in a pawl.

14. The engine hood hinge as claimed in claim 13, wherein the pawl is actuable by a trigger.

15. The engine hood hinge as claimed in claim 8, wherein the multi-bar linkage mechanism is a four-bar linkage mechanism.

16. The engine hood hinge as claimed in claim 10, wherein the lever arm is kept under prestress.

17. The engine hood hinge as claimed in claim 10, wherein the lever arm is held by a retaining clip in a pawl.

18. The engine hood hinge as claimed in claim 11, wherein the lever arm is held by a retaining clip in a pawl.

19. The engine hood hinge as claimed in claim 12, wherein the lever arm is held by a retaining clip in a pawl.

20. The engine hood hinge as claimed in claim 17, wherein the pawl is actuable by a trigger.

21. The engine hood hinge as claimed in claim 18, wherein the pawl is actuable by a trigger.

22. The engine hood hinge as claimed in claim 19, wherein the pawl is actuable by a trigger.

23. The engine hood hinge as claimed in claim 14, wherein the trigger is a magnetic trigger.

24. The engine hood hinge as claimed in claim 20, wherein the trigger is a magnetic trigger.

25. The engine hood hinge as claimed in claim 21, wherein the trigger is a magnetic trigger.

26. The engine hood hinge as claimed in claim 22, wherein the trigger is a magnetic trigger.
